(19) United States
(12) Patent Application Publication
(10) Pub. No.: US 2011/0297542 A1
(43) Pub. Date: Dec. 8, 2011

(54) METHOD OF FABRICATION OF MONOLITHIC STATIONARY PHASES FOR SEPARATIONS, AND METHODS OF SEPARATION USING SUCH STATIONARY PHASES

(75) Inventors: Malcolm Smyth, Ashbourne (IE); Aoife Morrin, Dublin (IE); Blanaid White, Dublin (IE); Anthony Killard, Malmesbury (GB); Nie Fuqiang, Beijing (CN)

(73) Assignee: DUBLIN CITY UNIVERSITY, Dublin (IE)

(21) Appl. No.: 13/133,619

(22) PCT Filed: Dec. 8, 2009
(86) PCT No.: PCT/EP2009/066645

§ 371 Date: Aug. 25, 2011

(30) Foreign Application Priority Data
Dec. 8, 2008 (GB) 0822339.8
Dec. 8, 2008 (GB) 0822340.6

(51) Int. Cl. G01N 27/447; C25D 1/12

(52) U.S. Cl. 204/451; 204/483; 204/600

(57) ABSTRACT

Analysis tools for use in analytical separations are provided including a stationary phase comprising an electroconducting material, for example, a conducting polymer. There is further provided a method for manufacturing monolithic stationary phases in various formats including in chip-format, column or capillary column format and method of separation using stationary phases. Also provided is a method for analytical separation comprising selective manipulation of the stationary phase making it is possible to tune the device to specific applications.

### FIELD

The present specification relates to analysis tools or devices that are usefully employed in analytical separations including for example chromatographic or electrophoretic applications, size exclusion, hydrophobicity and ion exchange separations.

The present specification describes analysis tools that incorporate 3D monolithic stationary phases. Such monolithic stationary phases may be manufactured in various formats including in chip-format, column or capillary column format. The specification also describes a method of separation using stationary phases.

The present specification describes a stationary phase comprising an electroconducting material for example a conducting polymer and a method for selective manipulation of the stationary phase to tune the device to specific applications.

### BACKGROUND

Liquid chromatography (LC) is a widely used and powerful analytical technique. As a generic term it is used to describe any number of specific techniques that usefully provide for a separation of mixtures. By passing the mixture dissolved or provided within a mobile phase through a stationary phase it is possible to separate the constituents of the mixture so as to separate the analyte to be measured from other constituents of the mixture. In this way, such techniques are based on a partitioning of the analyte between the mobile and the stationary phases. In accordance with standard or conventional terminology within the present specification the term “analyte” is intended to define the substance that is to be separated during chromatography, the term “stationary phase” includes the substance or material that is fixed in place for the chromatography and the term “mobile phase” includes the sample that is to be separated or analysed and the solvent within which the sample is carried.

Reversed phase stationary phases are the most popular type used in chromatography. Industrial demands for enhancements in its separation power have lead to a number of recent advances in the field. These include introducing microbore and capillary columns. However, as the internal diameter of the columns decreases, significant pressure problems arise. These have been addressed to an extent by Ultra Pressure Liquid Chromatography (UPLC) or monolith stationary phases. However, reducing the size of the particles used in the stationary phase, requires an increase in the pressure driving the mobile phase through the column. Standard High Performance Liquid Chromatography (HPLC) tends to use particles of around 3.5 μm in size and pressures of around 3000 psi. In UPLC, the particle size has been reduced to 1.7 μm, which generate pressures of around 12,000 psi, necessitating the use of custom designed pumps. Thus there is a further problem that these columns cannot be interfaced to existing conventional HPLC instrumentation. A disadvantage of current monolithic columns is that they require high flow rates and therefore an increased solvent consumption.

Capillary columns are normally efficient at low flow rates and may be directly interfaced to powerful detection techniques such as mass spectrometry (MS) and are still operational within the usual pressures of standard HPLC instrumentation. However, the use of capillary monolithic columns has been hindered by limitations of the fabrication of a homogenous polymer monolithic stationary phase. Two primary methods for fabrication of organic polymer monoliths involve either ultraviolet (UV) or thermal curing processes.

UV curing requires that UV-transparent capillaries be used throughout the fabrication process; this introduces problems in that these capillaries are not as structurally sound as conventional capillaries, i.e., those with polyimide coating. Thermal curing is an exothermic reaction, and as the length of the capillary increases, it becomes increasingly difficult to dissipate the heat generated during the unstirred polymerisation. This leads to heterogeneities in the pore structure. Silica-based monoliths are prepared in PEEK moulds then attached to stationary phases. Due to shrinkage, preparation of straight rods of longer than 15 cm is difficult.

Therefore, there are problems associated with the fabrication of capillary columns that limit their use and applications, and further problems associated with the operation and use of monolithic stationary phases in separations for example with control of bulk flow and the requirements for external pumping that need to be addressed.

The invention is aimed at addressing these and other problems of the prior art.

### SUMMARY

These and other problems are addressed by the present teaching which provides a method of fabricating a stationary phase of an analysis tool for subsequent use in analytical separations. The method includes the steps of electrochemically growing the stationary phase from a material comprising an electroactive or conducting monomer by effecting a polymerisation of the monomer. An analysis tool including such a stationary phase is also described.

Accordingly there is provided a method of claim 1. Advantageous embodiments are provided in the dependent claims thereto.

There is further provided an analysis tool or device incorporating a stationary phase whose properties may tuned to the specific separation technique being undertaken. Such a stationary phase may be provided by a material comprising an electroactive or conducting monomer by effecting a polymerisation of the monomer. The properties of the ultimate stationary phase may be modified by the application of a potential to that stationary phase either during fabrication or during the actual separation being undertaken.

Accordingly there is provided an analysis or device according to claim 55. Advantageous embodiments are provided in the dependent claims thereto.

According to a first aspect there is provided a method of fabricating an analysis tool having a monolithic stationary phase for use in analytical separations comprising electrochemically growing the stationary phase from a material comprising an electroactive or conducting monomer by effecting a polymerisation of the monomer.

In one embodiment the method comprises applying a potential to the monomer during the polymerisation process to control the electrochemical growth and ultimate properties, for example, porosity and/or hydrophobicity and/or ionic state and/or oxidation state and/or colour, of the resultant stationary phase. The method may comprise applying a sweep potential during the polymerisation process, or, modulating the potential to modulate the properties of the resultant polymer. In one embodiment the method of electrochemically growing comprises a potentiostatic method, or, a potentiodynamic growth method, or, a galvanostatic method.

In one embodiment the monomer comprises Aniline and the stationary phase comprises the polymer porous Polyaniline (PANI). The method may comprise providing a passive or chemical attachment to the monomer. The method may comprise compositing the polymer with another conducting material, for example a conducting metallic material or metallic nanoparticles, or, compositing the polymer with another conducting non-metallic material, for example carbon nanotubes, or, combining the polymer with a metallic complex. The polymer may be configured as a host to facilitate modulation of conductivity. In another embodiment the method comprises adding a dopant to the monomer during polymerisation. The dopant may be selected to control the structure and/or redox properties of the stationary phase. The dopant may comprise an ionic dopant configured to effect retention of an analyte in the resultant stationary phase during a separation.

Preferably, the stationary phase is grown in a channel to which an electrode configuration is applied. The electrode configuration may comprise a working electrode having a 2-dimensional characterisation corresponding to the ultimate 2-dimensional characterisation of the resultant stationary phase.

In another embodiment the method further comprises providing a template configured to define the pore size and structure of the stationary phase, and electrochemically growing the stationary phase in the presence of the template. Preferably, the template is deposited in the channel prior to polymerisation of the monomer. The method may comprise co-depositing the template with the polymer by electropolymerisation of the monomer in the presence of the template. Preferably the method comprises preselecting the template dimensions to define the pore size of the resultant stationary phase. In one arrangement, the template may be configured to define permselective pores, typically having dimensions of <100 nm. In another, the template may be configured to define pores of dimensions >20 nm. In a further, arrangement the template may be configured to define pore sizes of >100 nm for electro-osmosis. In a further embodiment the method includes the subsequent removal of the template. The template may comprise a soluble material configured to be dissolved after the stationary phase is grown.

In one embodiment the method comprising fabricating the monolithic stationary phase in one of chip or microchip format, column or capillary column format.

According to a second aspect there is provided a method of fabricating an analysis tool for use in analytical separations, the tool having a monolithic stationary phase formed by the steps of:
providing an electroactive or conducting monomer,
applying a potential to the polymer to effect an electropolymerisation of the monomer to grow the stationary phase.

In one embodiment the method further comprises:
providing a separation channel with an electrode cell configuration applied thereto,
introducing the monomer to the channel,
applying a potential via the electrode cell configuration to the monomer to electrochemically grow the stationary phase.

In another embodiment the method comprises controlling the potential to control the growth conditions and the ultimate properties of the stationary phase including for example, porosity and/or density and/or hydrophobicity and/or ionic state and/or oxidation state and/or colour. Preferably the method includes controlling the potential to modulate the properties of the polymer. In a further embodiment the method comprises fabricating the stationary phase in a chip or microchip wherein the channel is provided in chip. Preferably the chip comprises a bottom plate and a top plate arranged in a sandwich structure. The method preferably comprises forming the separation channel in the bottom plate. The electrode cell configuration preferably comprises a working electrode, a reference electrode and an auxiliary electrode. The method may comprise applying a potential between the working and reference electrodes to induce electrochemical polymerisation of the monomer. The method may comprise sputter coating the base of the channel with a conducting material to form the working electrode. The working electrode may comprise gold. The method may comprise sealing the top and bottom plates. The top and bottom plates may be sealed using a pressure sensitive adhesive. The method may comprise providing a membrane over the reference and auxiliary electrodes, the membrane being configured to prevent the system from short-circuiting as a stationary phase is grown. The electrode cell configuration may comprise control means for applying and controlling the potential applied while the stationary phase is being grown. The stationary phase may comprise an aniline polymer. The method may comprise providing the monomer by flow. The method may further comprise providing a template configured to define the pore size and structure of the stationary phase, and growing the stationary phase in the presence of the template. The method may further comprise locating the template in a channel, the channel defining the ultimate location of the stationary phase. The method may comprise adding a dopant to the material of the stationary phase during polymerisation. The dopant is preferably selected to control the structure and/or redox properties of material of the resultant stationary phase.

In one embodiment, the stationary phase comprises a 3D monolithic stationary phase. In another embodiment, the stationary phase comprises a monolithic HPLC stationary phase.

According to a third aspect the present specification provides an analysis tool for use in analytical separations having a monolithic stationary phase wherein the stationary phase is at least partially comprised of an electroactive or conducting polymer and wherein the stationary phase is grown electrochemically.

According to the a fourth aspect the present specification provides an analysis tool for use in analytical separations having a monolithic stationary phase, the stationary phase comprising an electroactive or conducting polymer wherein the stationary phase is grown by electropolymerisation by the application of a potential to the monomer to form the polymer stationary phase.

According to a fifth aspect, there is provided a capillary column comprising the analysis tool described.

According a sixth aspect the specification provides a capillary electrochromatography (CEC) analytical separation analysis device fabricated at least partially from a conducting or electroactive polymer, properties of the stationary phase being controllable by application of a potential thereto.

The conductivity of the stationary phase is preferably controllable by modulation of a potential applied thereto. Preferably, the application of a potential to the stationary phase enables modification of the stationary phase properties of at least one of:

Porosity; Density; ionic capacity; hydrophobicity; conductivity; oxidation state; colour.

In one embodiment, the stationary phase is configurable such that its properties may be dynamically modified during a separation process. The dynamic modification is operably provided to tune the properties stationary phase to the properties of the analytes to be separated during the separation process. Preferably, the conducting or electroactive polymer is a porous polymer. The polymer may comprise Polyaniline (PANI). The stationary phase may be configured to be regenerable by application of a potential to expunge analytes therefrom.

According to a seventh aspect there is provided a capillary electrochromatographic analytical separation method for identification of sample analytes comprising steps of:
Providing an analysis tool of having a stationary phase comprising a conducting or electroactive material;
Applying a potential to the stationary phase to modify and tune the properties of the stationary phase.

In one embodiment, the method comprises applying a potential to the stationary phase during the separation of the sample analytes. The method may comprise dynamically adjusting the potential applied during separation of the sample analytes to dynamically modify the properties of the stationary phase as the separation progresses. The method may comprise selecting and adjusting the potential applied to the stationary phase based on the sample analyte types and/or properties.

Preferably, the stationary phase comprises a porous polymer. Most preferably, the stationary phase comprises Polyaniline (PANI).

In another embodiment the method comprises varying the potential applied to vary the porosity or pore size of the stationary phase to enable dynamic size exclusion. The potential applied may be varied the hydrophobicity of the stationary phase to control analyte retention, and/or to vary the conductivity of the stationary phase, and/or to vary the ionic capacity of the stationary phase enabling ion-exchange chromatography. In a further embodiment, the method comprises applying or varying the potential applied to the stationary phase during a separation to effect oxidation or reduction of analytes therein.

These and other features will be better understood with reference to the exemplary embodiments which follow and which are provided to assist in an understanding of the teaching and benefit of the invention but which are not to be construed as limiting in any fashion.

### BRIEF DESCRIPTION OF THE DRAWINGS

The present invention will now be described with reference to the accompanying drawings in which:

FIG. 1 is a process flow showing an exemplary technique for fabrication of a device in accordance with the present teaching.

FIG. 1A is a schematic showing how a device during the fabrication process of FIG. 1.

FIG. 1B is a schematic showing how a device during the fabrication process of FIG. 1.

FIG. 1C is a schematic showing how a device during the fabrication process of FIG. 1.

FIG. 1D is a schematic showing how a device during the fabrication process of FIG. 1.

FIG. 1E is a schematic showing parameters and components that may be used in fabrication of a device in accordance with the present teaching.

FIG. 2 is a graphical representation of a fabricated chip.

FIG. 3 is a top view of a graphical representation of a microchip showing an etched channel, with sample and background electrolyte (BGE) inlets, and sample and BGE waste outlets with an SEM image of the honeycomb structure of the polymer forming the stationary phase embedded therein.

FIG. 4 is a photographic representation of an assembled microchip.

FIG. 5 is an illustration of cyclic voltammograms of 2 mM K₃Fe(CN)₆ (ferricyanide) in 1M KCl at a scan rate of 100 mVs⁻¹ performed in the chip, using a gold sputtered channel as the working electrode and the silver chlorinated and platinum wires as the reference and auxiliary electrodes respectively.

FIG. 6 shows cyclic voltammograms of a polyaniline/poly(vinyl sulphonate) (PANI/PVS) polymer in an aqueous HCl (1 M) solution, at a scan rate of 100 mV s⁻¹, with the growing peaks indicating growth of the polymer in the channel performed in the chip, using a gold sputtered channel as the working electrode and the silver chlorinated and platinum wires as the reference and auxiliary electrodes respectively.

FIG. 7(a) is a photographic representation of the microchip with the PANI monolith grown on the separation channel (shown in black).

FIG. 7(b) is a Scanning Electron Microscope (SEM) image of the PANI monolith (300× magnification), illustrating that the polymer monolith has completely filled the separation channel of the microchip.

FIG. 7(c) is a SEM image of the PANI monolith (5000× magnification), with the polymer structure and the pores within the structure clearly visible.

FIG. 8 is a series of SEM images, at increasing resolution, of the monolithic polymer grown at a potential of 1.0 V vs. Ag/AgCl (left hand side) and 0.8 V vs. Ag/AgCl (right hand side).

FIG. 9 is a graphical representation of an electroactive monolithic chip according to an arrangement of the present specification; The separation channel containing the electroconducting polymer is illustrated with the insert A showing an SEM image of the possible structures that can be fabricated;

FIG. 10 is a Scanning Electron Microscope (SEM) image of a separation channel packed with the polystyrene bead template;

FIG. 11 is an SEM image of the bare polystyrene (PS) sphere template (5000× magnification) packed into the chip channel, illustrating the highly ordered structure of the template;

FIG. 12 is an SEM image of a PANI monolithic polymer (10,000× magnification) which has been grown through a structured PS template and the template subsequently removed. This image clearly illustrates the interconnected honeycomb structure of the final monolith fabricated according to a method of the specification;

FIG. 13 is an SEM image of a PANI monolithic polymer (5000× magnification) which has been grown through a structured PS template and the template subsequently removed. This image illustrates the 3D interconnected honeycomb structure of the monolith. The frays in the monolithic structure observed in this image are artefacts caused by removal of the monolith from the chip channel, which was achieved using adhesive strips.

### DETAILED DESCRIPTION OF THE DRAWINGS

The present specification describes an analysis tool or device for use in analytical separations including for example chromatographic or electrophoretic, size exclusion, hydrophobicity and ion exchange separations. In accordance with the teaching of the present invention such an analysis tool comprises a stationary phase which is at least partially comprised of or fabricated from an electroactive or conducting polymer.

Such a polymer may be grown electrochemically. The stationary phase is grown by electropolymerisation techniques effected by the application of a potential to a monomer. A method for fabrication of such a stationary phase is also described.

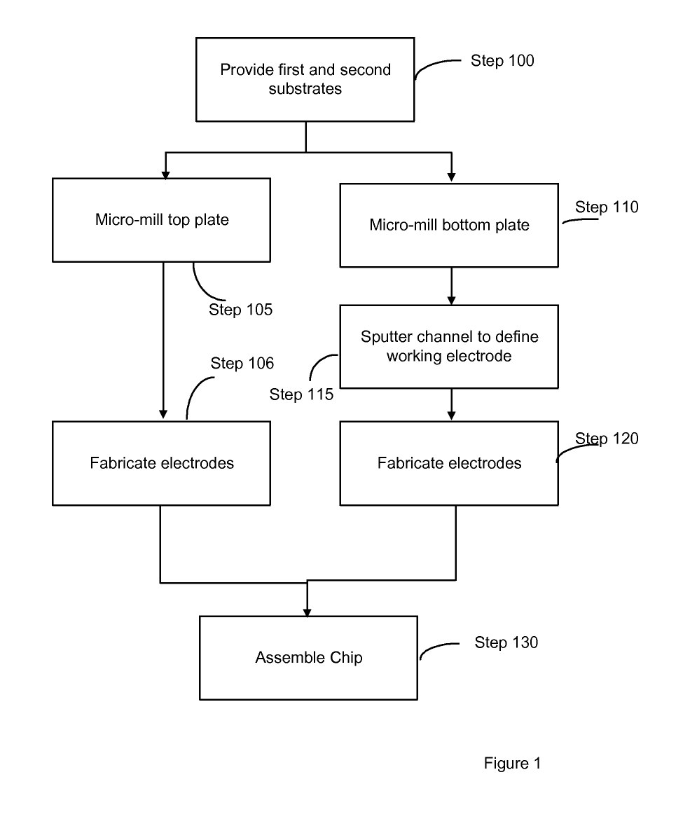

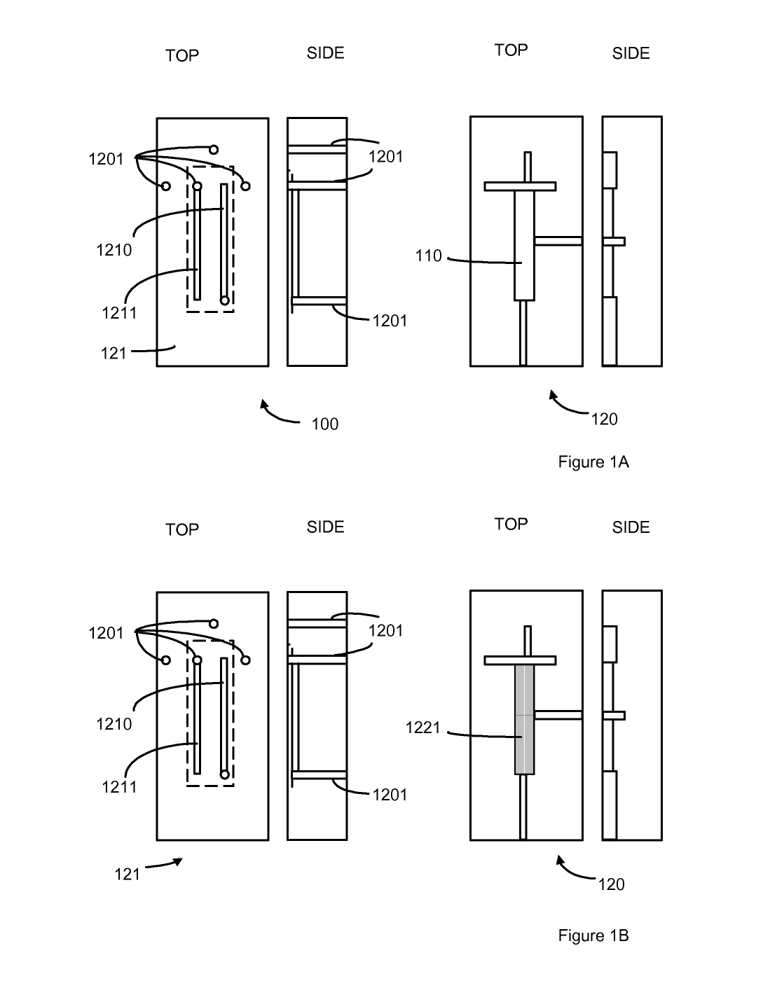

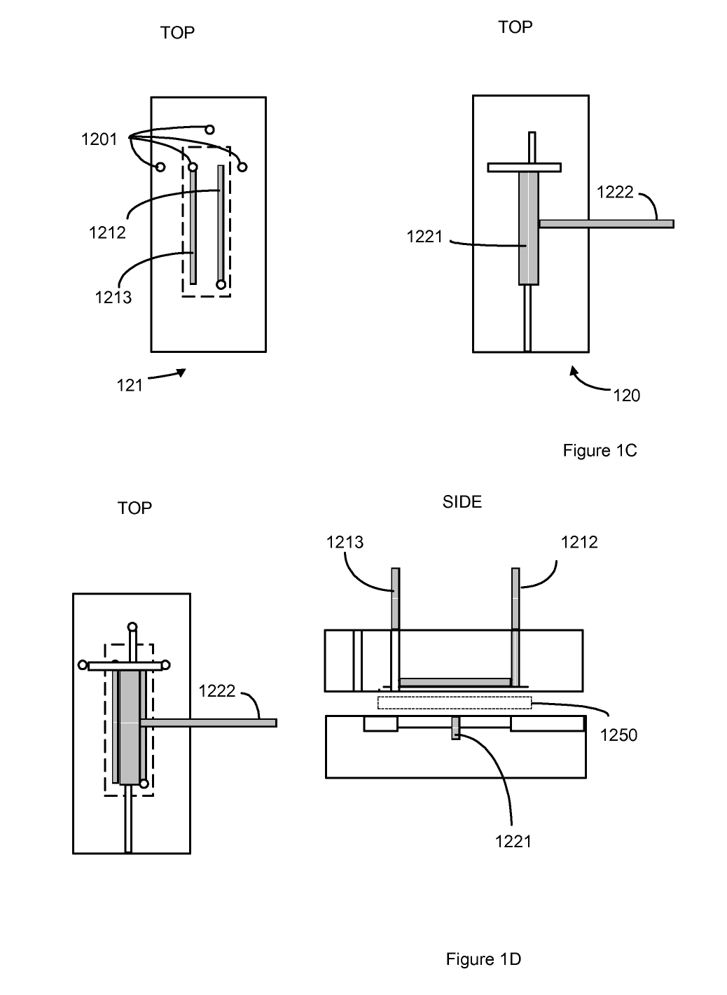

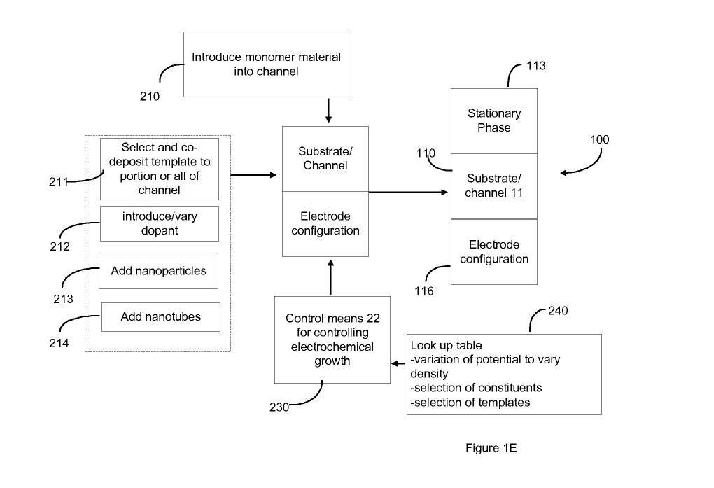

Referring to the drawings and in particular initially to FIGS. 1 to 4, a stationary phase or column of an analysis tool for use in separations is described. The stationary phase or column is electrochemically grown from a material comprising a conducting or electroactive monomer material by effecting a polymerisation of the monomer material to provide a corresponding polymer. Examples of a suitable material include aniline which is electrochemically grown and polymerised to form polyaniline.

The stationary phase 13 may be provided as part of a microchip system 100 comprising a separation channel 110 having an electrode cell configuration 116 associated therewith. Using such a chip system, it is possible to use the electrode cell configuration 116 to provide for electrochemical growth of the electroactive or conducting monomer by effecting a polymerisation of the monomer to form a monolithic stationary phase or column 113.

Typically, an electrode cell configuration 116 will comprise a working electrode 1221 (fabricated typically from gold or similar materials) and reference 1213 and auxiliary 1212 electrodes. The microchip 100 may comprise a bottom plate 120 and a top plate 121, with the channel 110 desirably formed in the bottom plate 120. In this exemplary arrangement, a gold working electrode 1213 may be sputter-coated to the base of the channel 110 on the bottom plate 120, and metallic wires, for example, a silver wire and platinum wire may be inserted into sub-channels formed on the top plate 121 so as to provide the reference and auxiliary electrodes 1213 and 1212 respectively. It will be appreciated that other methods of forming the reference and auxiliary electrodes could also be employed without departing from the present teaching. The two plates 120 and 121 may be sealed together using pressure sensitive adhesive. A Polyvinylidene Fluoride (PVDF) or other insulating membrane 1250 may be laid over the reference and auxiliary electrodes 1213 and 1212 to prevent the system 100 from short circuiting as the monolithic stationary phase is grown. Electrical contact to each of the electrodes may be provided by providing an electrical path through sub-channels in the bottom and top plates to effect electrical contact with the electrodes from outside of the sealed plate arrangement. This could also be achieved by having portions of the electrodes protrude through the external surfaces of the plates.

The electrode cell configuration 116 may include control means for controlling the potential applied while the stationary phase or column is being grown. In this case, the potential is applied by means of the protruding working, reference and auxiliary electrodes.

An exemplary flow sequence for fabrication of such a device will now be described with reference initially to FIG. 1 (which shows an exemplary flow sequence) FIGS. 1A through 1D which show corresponding schematics of the form of the device after each step, a device 100 provided in accordance with the teaching of the present invention may be fabricated from two parts—a top plate 121 and a bottom plate 120, each being formed from for example Poly(methyl methacrylate) (PMMA). PMMA provides a bulk substrate which may be suitably processed to fabricate a microchip arrangement.

In Step 100, each of the first and second substrates are provided. Subsequent to this provision the processing of the individual plates prior to the final chip assembly may be effected concurrently or sequentially. The flow sequence of FIG. 1 shows this as two parallel operations but it will be understood that it is not intended to limit the present teaching to such an exemplary arrangement.

In Step 105, and as shown in FIG. 1A, the top plate 121 is processed to define channels within the substrate for an electrode assembly. Two channels 1210, 1211 are defined which will be subsequently used to define the constraints of a reference and auxiliary electrode. A plurality of vias 1201 are provided, and these will be used subsequently for providing electrical contact to the electrodes.

With continued reference to FIG. 1A, in a corresponding processing of the bottom plate, Step 110 shows how the surface of the bottom plate substrate may be milled to form a template for the working electrode and a separation channel 110.

Once this template has been fabricated, a lower surface of the channel may be sputter coated with a conducting material such as gold to form the working electrode 1221 (Step 115), FIG. 1B.

Each of the top and bottom plates are then processed to fabricate electrodes. As shown in Step 106/FIG. 1C, the channels fabricated on the top plate in Step 105 are provided with metallic wires for example, a silver wire and platinum wire to provide the reference and auxiliary electrodes 1213 and 1214 respectively. In parallel, or sequentially, Step 120 provides for equivalent processing of the bottom plate 120 by provision of connecting wires 1222 for the working electrode 1221.

Once each of the top and bottom plate is suitably processed they may be brought together (Step 130) to form the final chip assembly. The upper surfaces of each of the top and bottom plate are presented to one another and the two plates 120 and 121 may be sealed together using for example a pressure sensitive adhesive. Prior to sealing an insulating membrane 1250 such as that provided by polyvinylidene fluoride (PVDF) membrane may be laid over the reference and auxiliary electrodes 1213 and 1214 to prevent any short circuits during the operation of the device. Electrical contact to each of the electrodes may be provided by providing an electrical path through respective ones of the bottom or top plates to enable electrical contact with the electrodes from outside of the sealed plate arrangement. This could be effected by having portions of the electrodes protrude through the external surfaces of the plates as is shown in FIG. 1D or by providing electrical contact through the vias that are fabricated in the device.

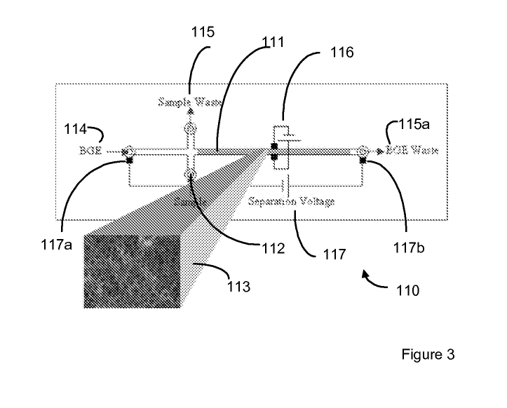

In operation as shown in the schematics of FIGS. 1E and 3, to effect growth of the stationary phase, raw material 114 for the stationary phase 113 is electrochemically grown is introduced to a first end of the channel 110, in a fluid form such that it may flow into and along the defined channel—step 210. The starting raw material for the stationary phase 113 of the exemplary embodiment comprises an aniline monomer. This aniline monomer may be introduced in the presence of acid and/or dopant into the 3-electrode cell configuration 110. A potential, or a potential sweep may be applied—step 230—between the working and reference electrodes using galvanostatic, potentiostatic or potentiodynamic modes to induce an electrochemical polymerisation of the monomer, resulting in growth of the insoluble polymer, in this case of polyaniline (PANI) to form the monolithic stationary phase within the channel.

As was mentioned above, the channel 110 is desirably formed on what will ultimately be a bottom plate of the microchip and is typically formed by etching or micro milling processes. The on-channel working electrode 1221 may be fabricated by sputtering gold or other suitable metals directly to the microchip. As alternatives to sputter-coating screen-printing, spin-coating, inkjet printing or spraying techniques may be used.

The resultant stationary phase 113 comprises an electroactive or conducting polymer and the properties thereof such as porosity, hydrophobicity, and ionic state, oxidation state and colour may be controlled by tuning the electrochemical growth conditions of the monomer 114 during the polymerisation process.

Methods of controlling the properties and structure of the stationary phase include one or more of the following:

1. By varying the electrochemical growth conditions or fabrication method (step 230)
2. By utilising a templating approach (step 211)
3. By using a dopant or varying the dopant used (212)
1. The stationary phase or column 113 may be grown by a range of electrochemical methods including for example galvanostatic, potentiostatic and potentiodynamic methods. The properties of the column may be defined by the step 230 of controlling of the electrochemical conditions used to grow it. For example, when using a potentiostatic method, by varying the positive potential used for the electropolymerisation, the porosity of the resulting material will change. Also, employing a highly positive potentiostatic potential will allow hydrolysis reactions to happen at the surface of the electrode, inducing a different structure than would be obtained if using a potentiodynamic method where the potential is swept over a range of potentials. Variation of the applied potential for potentiostatic methods provides for manipulation of monolith pore size and density. Similarly, varying the potential limits and the scan rate in potentiodynamic methods, and varying the constant current density applied for galvanostatic methods will effect pore size and density.
2. The form of stationary phase 13 may be further structured by the step 211 of using a template. The template may be usefully employed to define the size and/or form of pores in the stationary phase. Such a template may be provided in the form of a removable template which may be initially deposited in the channel 110, so that it fills the channel with a repeating highly ordered pattern. To generate such a pattern a lattice type structure for example of micro or nano-sized beads may be used. To effect removal of the template it may be formed of soluble material for example latex or silica, such that when the stationary phase 113 is grown, the template may be dissolved to leave a honeycomb structure of well-defined pores. The template may also be co-deposited with the polymer by electropolymerisation of the monomer in the channel in the presence of the nanotemplate.

It will be appreciated that if used that the size and form of the template is important, as it may be configured to define a pore size such that electro-osmosis in the channel is influenced. By providing a nano-dimensioned or nanotemplate it is possible to configure the template to define pores having dimensions in the range of <100 nm to around 1000 nm at which dimensions electro-osmosis is possible. Electro-osmosis is best described as the movement of liquid relative to a stationary charged surface under an applied electric field. The ionization of the stationary phase gives rise to a negatively charged surface, which affects the distribution of nearby ions in solution. Ions of opposite charge (counter-ions) are attracted to the surface to maintain the charge balance whilst ions of like charge (co-ions) are repelled. A double layer of electric charge may be thus formed. Using pore sizes of between 100 and 1000 nm, the pores generated are large enough to prevent overlap of the electrical double layer, and as such are configured to support perfusive through-pore flow. Cations, anions and neutral species can all permeate the monolithic stationary phase with these pore sizes. In contrast, by nanostructuring the conducting polymer materials using a template of less than 100 nm, the porosity may be finely tuned so that an overlap of the electric double layer within the pore occurs. This provides a permselective material, configured to selectively allow either cations or anions to progress through the stationary phase.

Templates of different forms may be used as required. For example for particular analytical application of the resultant stationary phase the template may be selected to define a stationary phase having highly ordered form or alternatively to define a stationary phase having a non-ordered form. The material of the soluble template and the solute are selected to ensure that the form of the stationary phase is not affected by the solute. Similarly, in application using a solute the substrate selected will be typically be insoluble such that any solvent that is used to subsequently dissolve the material used for the template does not concurrently dissolve of other elements of the chip.

3. Fabrication may include the step 212 of doping the material of the stationary phase or column 113 during polymerisation. Using strong (e.g., Cl⁻) or doubly charged (e.g., SO₂⁻) anions to dope the positively charged backbone of the polymer will affect ionic strength and therefore analyte retention in a separation. The ability to dope the polymer provides the ability to utilise the monolith for anion-exchange chromatography. In addition, depending on the dopant used, the structure and redox properties of the polymer can be influenced.

Thus specific properties of the stationary phase or column 113 may be varied during fabrication as required.

TABLE 1
Optimisable parameters during fabrication:

| Fabrication | Result on | |
|---|---|---|
| Parameter | Final Separation | Example |
| Nanotem- | Creation of permselective pores; | Direct analysis of |
| plating | only anions or cations allowed | biological samples, |
| 211 <100 nm | through | e.g. plasma, |
| | | extracellular fluid, |
| | | blood samples |
| Nanotem- | Creation of perfusive through flow | Protein |
| plating | pores; electroosmosis enhanced | purification |
| 211 | | |
| 100-1000 nm | | |
| Variation of | More densely packed stationary | Metabonomic |
| applied | phase, increased surface area for | analysis |
| potential 230 | chromatographic adsorption | |
| Addition of | Increase in retention of counterions | Environmental |
| ionic dopant | in solution; enhancement of ion- | sample analysis |
| 212 | exchange chromatography | |
| Addition of | On column/capillary catalysis of | Breakdown of |
| carbon | selected analytes | interferants, e.g. |
| nanotubes | | hydrogen peroxide |
| 214 | | |
| Addition of | Increase in conductivity of stationary | Proteomic analysis |
| metallic | phase, enhancing existing parameters. | |
| nanoparticles | | |
| 213 | | |
| | Anchoring of biomolecules for | Antigen binding |
| | increased specificity | |

Referring to the above Table 1, the method of fabrication provides scope for variation of the properties of the resultant stationary phase by varying the inputs and/or conditions of fabrication. A look-up table 240 may be provided as a basis for selection of potential, material inputs and selection of template form 211 as required to produce the stationary phase tailored to the required analysis.

Characterisation of fabricated monolithic stationary phase was effected using Scanning Electron Microscope (SEM) techniques. Top down views and cross sections of the stationary phase using this technique have confirmed the expected permeable structure. The percentage of the channel filled with the polymer has been calculated by filling the polymer channel with liquid and comparing this volume to that when the channel was empty.

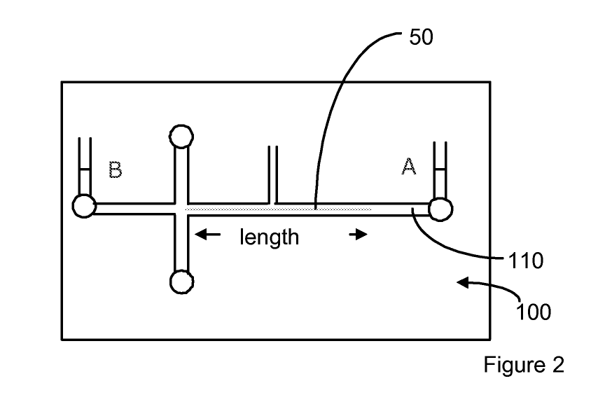

A protocol for calculation of the dead volume in the polyaniline monolith channel is provided with reference to FIG. 2 as follows, including:

1. The calculation of channel volume (shaded area—50) for polymerization: i.e. length×width×depth named as V_{Empty}. Referring to Table 2 below sample dimensions of a channel were taken as 19×1.5×0.02 mm,
2. The calculation of polymer volume:
The bottom plate may be bonded to the top plate to fabricate the microchip for polymerization. Referring to FIG. 2, before polymerization of the conducting polymer, one solution (e.g., PBS, named as S_{T}) may be introduced from A to B under the flow rate of 10 μl min⁻¹ (V) by syringe pump. The time from A to B is recorded as T₀.

The second step is to introduce the solution for polymerisation. After that, the same solution (S_{T}) is introduced from A to B similar as the first step under the same flow rate. The time is recorded as T₁. With the T₀ and T₁, the volume polymer possess can be calculated using:

V_{polymer}=(T₀−T₁)×V

3. Therefore, the dead volume can now be calculated:

V_{Dead}=1−V_{polymer}/V_{Empty}×100%=1−((T₀−T₁)×V)/V_{Empty}×100%

TABLE 2
calculations for dead volumes for polyaniline deposited by
cyclic voltammetry based on the above example dimensions:

| No. of electrodeposition | | |
|---|---|---|
| cycles of polyaniline | V_{polymer} | % V_{Dead} |
| 10 | 43.1 | 56.9 |
| 30 | 63.6 | 36.4 |
| 50 | 86.8 | 13.2 |

*

Accordingly, the method of fabrication described provides the ability to alter the stationary phase firstly by controlling the potential applied to electrochemically grow the conducting or electroactive material into a column, and secondly by the size and pattern of the template.

While in the example described, the stationary phase is formed from polyaniline (PANI), it will be appreciated that suitable alternative conducting polymers may also be used, for example: polyacetylenes, polypyrroles, polythiophenes, polyphenylenes, poly(phenylene sulfides), poly (phenylene vinylenes), polyazulenes, polycarbazoles, polyindoles, polypyrenes, polyazepines, polyfulvenes, polyindophenines, and polyanilines. (Further details of electrically conductive polymers are to be found in Ullman's Encyclopaedia of Industrial Chemistry, 6^{th} edition, volume 28, page 329 ff.)

A stationary phase may also be comprised of a conducting polymer composited with other conducting materials such as metallic materials (e.g., gold nanoparticles) and other conducting non-metallic materials such as carbon nanotubes. They may also be chemically combined with metallic complexes such as ruthenium complexes. For effective use as a stationary phase, the conducting polymer may be configured as the ‘host’ for these materials in order to facilitate modulation of the conductivity. The oxidation state of the conducting polymer have effects on the ultimate conductivity of the stationary phase. The monolithic stationary phase may also be of other suitable materials for example, porous silicon, the conductivity of which may be modulated.

Some exemplary steps and methods of fabrication are described:

### Example 1

### Design of Microchip with Gold Sputtered Working Electrode

### Materials

Polymethyl methacrylate (PMMA) was purchased from Radionics. Platinum wire (267228) for the auxiliary electrode and silver wire (327026) for the reference electrode were purchased from Sigma Aldrich. All other reagents were used as standard.

### Method

PMMA microchips of dimensions of the order of 400 mm width×500 mm length×4 mm depth were provided. The channels in the microchip were etched by direct micro-milling (Datron 3D M6, Datron Technology Ltd.). The separation channel in the bottom plate was of dimensions of the order of 27 mm length×1.4 mm width×40 μm depth. The two channels in the top plate were of length 26 mm×0.5 mm width×0.5 mm depth. A PVDF membrane of 26 mm length, 1.4 mm width was placed between the channels to prevent the circuit shorting during polymerisation.

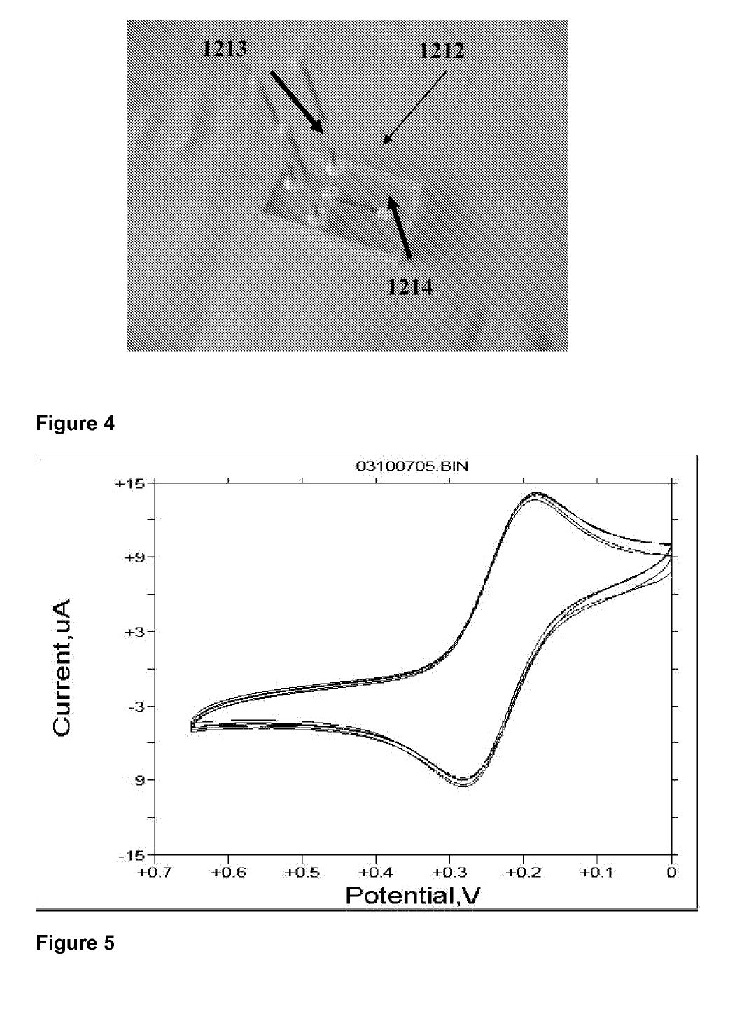

FIG. 1(a) shows an example overview of the chip design and FIG. 4 shows a photographic representation of the final assembled microchip.

### Example 2

### Monolith Preparation in Microchip Channel Using Electropolymerisation

### Materials

Aniline (from Aldrich 13,293-4) was vacuum distilled and stored frozen under nitrogen. Poly(vinylsulfonic acid) (PVS) sodium salt (PVS, 27,842-4 from Aldrich).

### Method

### Working Electrode Fabrication

The on-channel working electrode was fabricated by gold-sputtering the bottom plate using a SC7640 Sputter Coater (Quorum Technologies) with conditions: voltage of 2.5 kV and a current of 25 mA for 20 min. A silver wire was then inserted into the sub-channel and the bottom plate was gold-sputtered again to ensure electrical connectivity.

Ferricyanide (2 mM) in 1.0 M KCl was used to test the electrochemical response of the gold working electrode. FIG. 5 shows the cyclic voltammograms obtained from this analysis. The electroactivity of the on-channel gold electrode shows close to ideal electrochemical behaviour demonstrating it as a good electrode material for polymer electropolymerisation.

### Polyaniline Monolithic Growth

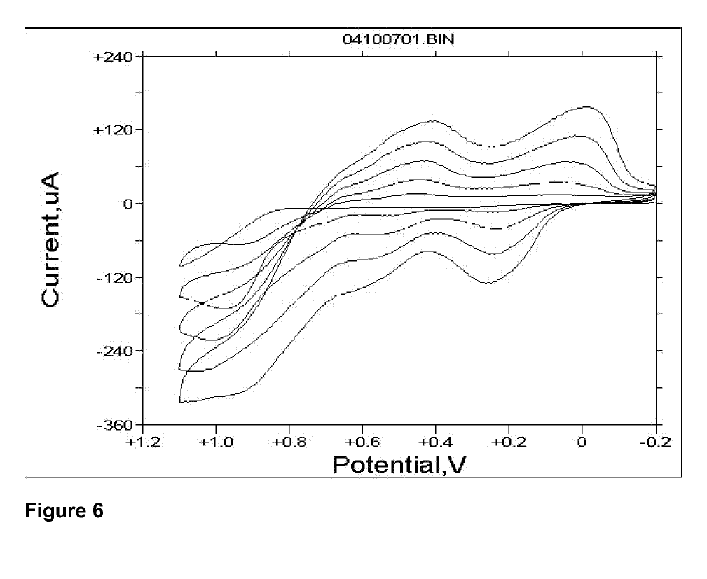

A mixture of 4.0 ml 1.0 M HCl, 9.1 μl distilled pure aniline and 1.0 ml poly(vinylsulphonate) (PVS) was degassed under nitrogen for about 10 min. The electropolymerisation of aniline to form polyaniline (PANI) was carried out either by cyclic voltammetry or at a constant potential using the 3-electrode cell incorporating the pseudo reference electrode by flowing the solution mixture through the channel over the gold electrode at a flow rate of 8 μl min⁻¹. FIG. 6 illustrates the resulting cyclic voltammetry that resulted when potentiodynamic cycling was used to grow the monolithic polymer. As the monolith grew, the resulting peak potentials increased, demonstrating that the polymer was growing in the channel.

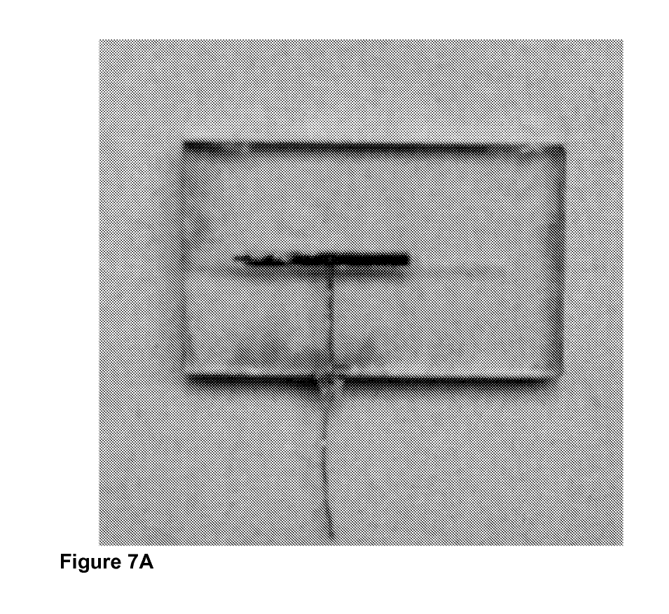

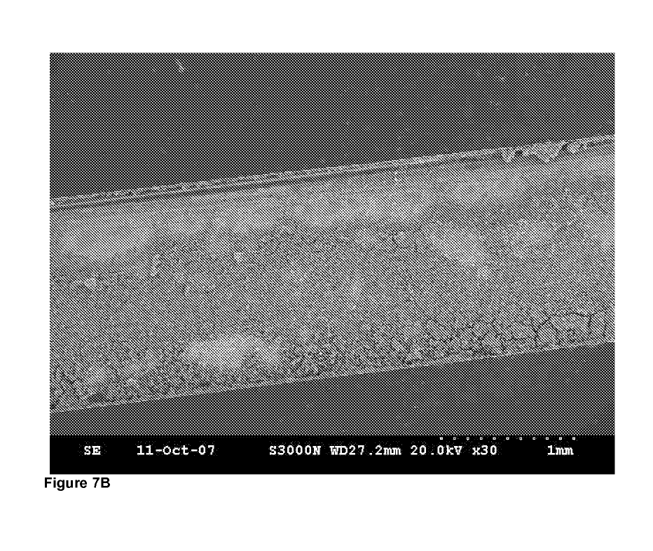

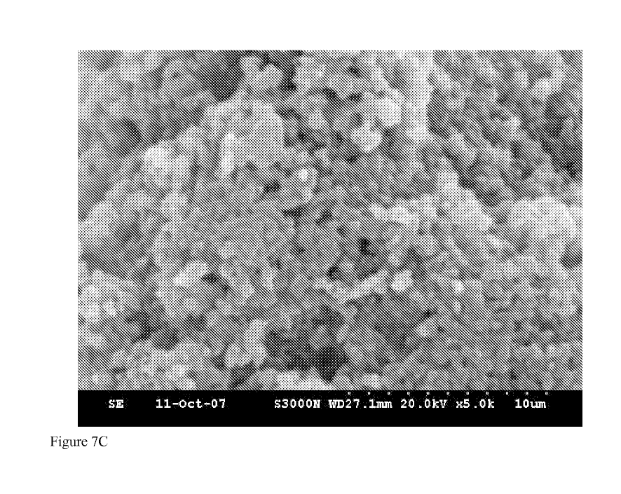

FIG. 7a is a photographic image of the monolithic PANI polymer grown on the microchip, clearly visible as a black surface. The filling of the channel by the monolith is visible in the scanning electron microscope (SEM) image in FIG. 7b. FIG. 7c, shows a high magnification SEM image of the polyaniline monolith grown in the channel. The polymer has a porous structure

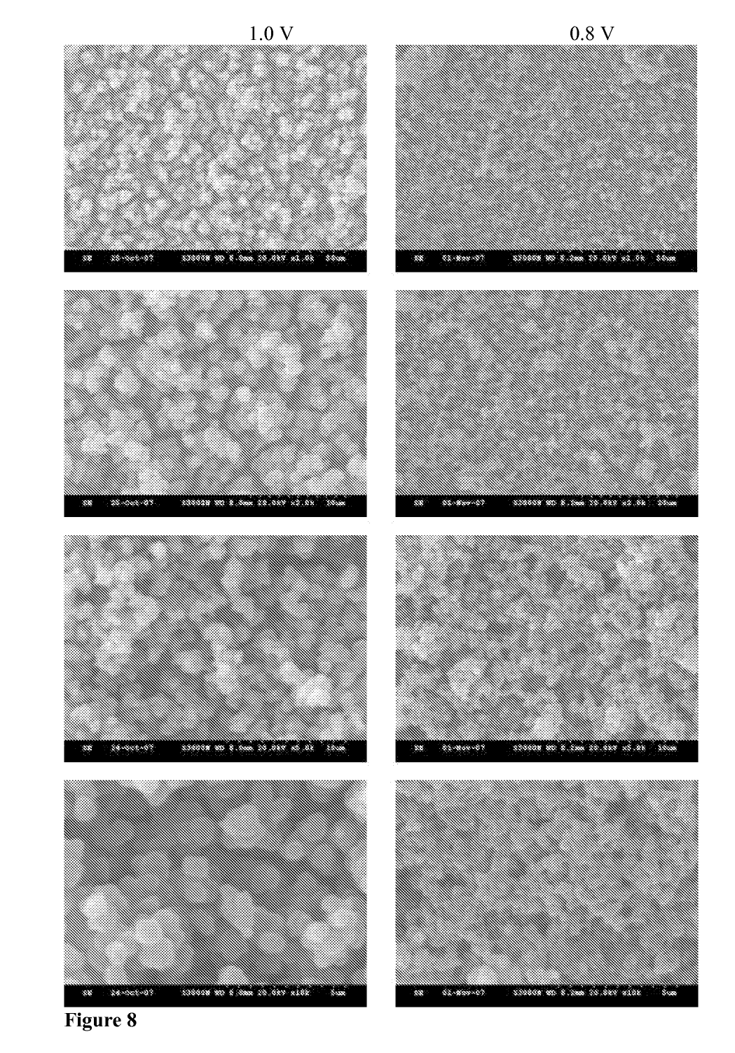

The potential at which the electropolymerisation was carried out was varied during bulk electrolysis (electrode held at constant potential), to investigate the extent to which pore size and monolith density could be controlled simply by polymerisation potential. As shown in FIG. 8, the polymer formed at 1.0 V vs. Ag/AgCl was significantly porous, while at a lower potential of 0.8 V vs. Ag/AgCl, the resulting polymer was far more densely packed with fewer and smaller pores.

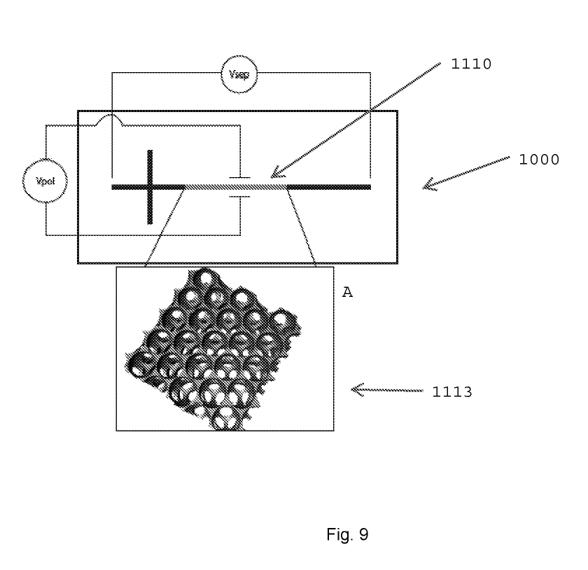

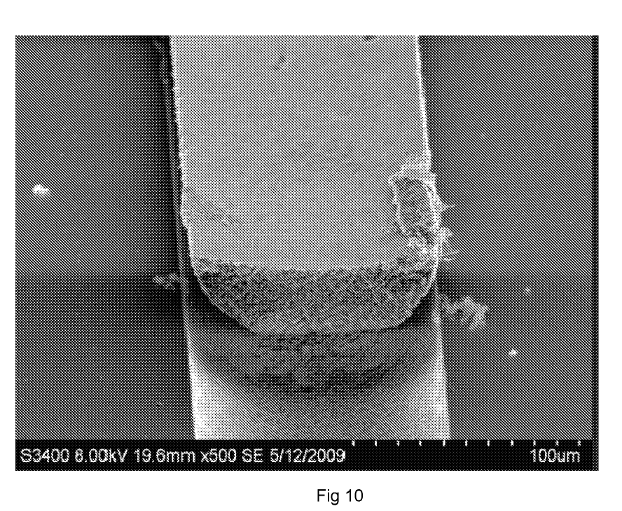

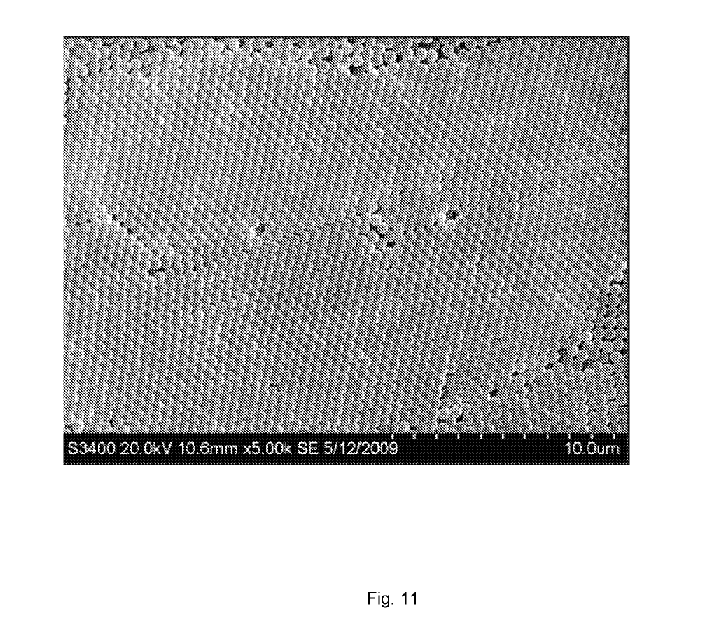

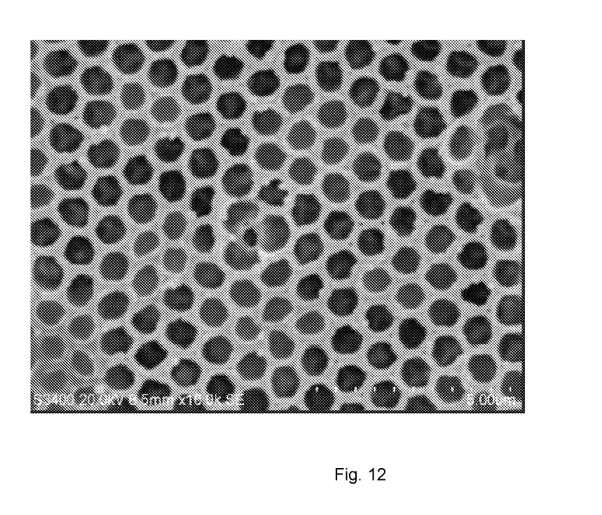

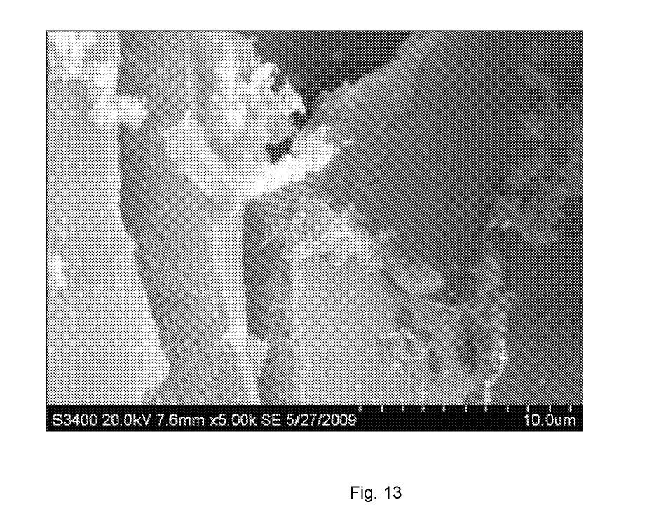

FIG. 9 is a graphical representation of an electroactive monolithic chip 1000 (the chip 1000 is similar to the chip 100 described above) according to an arrangement of the present specification. The separation channel 1110 containing the electroconducting polymer 1113 is illustrated with the insert A showing an SEM image of the possible structures that can be fabricated. FIG. 10 is a Scanning Electron Microscope (SEM) image of a separation channel 1110 packed with the polystyrene bead template and FIG. 11 is an SEM image of the bare polystyrene (PS) sphere template (5000× magnification) packed into the chip channel, illustrating the highly ordered structure of the template. FIG. 12 is an SEM image of a PANI monolithic polymer (10,000× magnification) which has been grown through a structured PS template and the template subsequently removed. This image clearly illustrates the interconnected honeycomb structure of a monolith fabricated by the method described. FIG. 13 is an SEM image of a PANI monolithic polymer (5000× magnification) which has been grown through a structured PS template and the template subsequently removed. This image illustrates the 3D interconnected honeycomb structure of the monolith. The frays in the monolithic structure observed in this image are artefacts caused by removal of the monolith from the chip channel, which was achieved using adhesive strips. The method described and the chip produced by the controlled method is advantageously highly reproducible.

FIGS. 10-13 show a highly ordered microstructure obtained by the method described herein and which is very reproducible. The templating approach described allows precise control over the microstructure of the resulting monolithic polymer, which is not achievable using prior art UV or thermal curing methods. This approach of the specification allows a reproducibility of monolith fabrication which is not provided in the prior art and the lack of reproducibility of monolith fabrication has hindered the commercial development of monolithic chromatographic technologies to date. The figures also demonstrate that an interconnected 3D honeycomb structure has been obtained, which is crucial to successful chromatographic applications.

The method of fabrication of monolithic columns and capillary columns comprised of conductive and electroactive materials in accordance with the present teaching is highly controllable and reproducible. The method provides for fabrication of monolithic columns and capillary columns as required in a reproducible and controllable manner, which can be customised according to separation criteria. The fabrication method described further provides stationary phases that can be manipulated so that both chromatographic and electrophoretic separations can be simultaneously applied and optimised and to allow for the integration of the separation techniques of size exclusion, hydrophobicity and ion exchange. This has the further advantage of providing improved separation efficiency, resolution and analysis time.

The method described herein provides for fabrication of pores of varying diameter (<100 nm-1000 nm) in monolithic structures. The resulting increase of the surface area of a stationary phase and the formation of highly defined uniform structures e.g., uniformly nanostructured monoliths advantageously provides improved performance in chromatography. Laminar flow is a prerequisite for traditional HPLC and in the prior art laminar flow is achieved using relatively slow runtimes. Monoliths obtained by the above fabrication method allow for laminar flow at higher flow rates by reducing the disturbances to the flow path of the mobile phase. Thus the nanostructured columns described permit laminar flow at higher flow rates and hence allow for optimal separation efficiency.

The switching properties of monolithic capillary columns and chips fabricated by the method described are improved in comparison with prior art columns. In particular such nanostructured materials have the advantages of high control, high surface area and not being a bulk material, but rather a material structured as required.

Fabrication as described using electrochemical and templating techniques offers an unprecedented level of control over the fabrication process itself. By controlling the size and pattern of the template nanostructure, the potential used to grow the polymer and the choice of polymer dopant, a homogenous polymer can be reproducibly generated. This advantageously provides for the fabrication of reproducible monolithic stationary phases. The method of fabrication described provides greater levels of control than existing polymerisation techniques. This control of structure of the column during fabrication is complimentary to the use of mobile phase gradients in HPLC for optimising separations.

Monolithic stationary phases or columns thus fabricated are suitable for use in separations, for example, capillary HPLC or capillary electrochromatography (CEC). In particular, the monolithic columns thus fabricated are configured to add additional separation parameters to separation methods. For example in the case of CEC, use of the monolithic capillary column provides an increased number of separation parameters including size exclusion, ionic interactions, and hydrophobicity control, substantially enhancing the resolving power of the CEC separation.

The inherent mechanical rigidity of conducting polymers for example, polyaniline has been found to be poor. The method described in the specification takes account of any potential mechanical rigidity problems that may have been expected to arise when the scaffold was removed. The method described in the present specification accordingly provides monolithic stationary phases having the required modulus or strength level for the intended applications.

Typically, the Young's Modulus of conventional fused silica is in the region of 100 GPa. However, silica with parameters suitable for application as a stationary phase in capillary or on-chip LC (i.e., length, diameter, cross sectional porosity) requires a Young's Modulus in the order of just 1 MPa. Stationary phases are conventionally characterised, not using Young's Modulus, but in terms of the pressure exerted on them during separations, the “column backpressure”. This pressure is proportional to the column diameter and length, pore structure of the column, the flow rate, etc. The maximum backpressure in a 50 micron diameter monolithic capillary is expected to be in the order of 100 MPa/m, which equates to about 10 MPa per 10 cm monolithic column. This figure is in agreement with the Young's Modulus expected for fused silica monolithic stationary phases, illustrating the ability of polymer stationary phases to withstand comparable pressures to silica. It is noted, that the backpressure of the electroactive or conducting polymer or polyaniline (PANI) monolithic column described is advantageously even lower, as a result of the enhanced microstructuring of this monolith.

The target modulus for a monolithic stationary phase of the type described herein, for example a monolithic stationary phase of PANI is of the order of 1-10 MPa. Particular forms of doped PANI (free-standing films) and wet-spun PANI fibres have reported Young's Moduli ranging from 1.5 MPa to 60 MPa, respectively. Although these levels may indeed be both sufficient and attainable using electrochemically grown bulk PANI (as described), increasing the structural integrity advantageously increases the pressures that the monolith can withstand, and radically boost its versatility. Compositing the polymer with inert/conducting epoxy resins and/or carbon nanotubes (CNTs) as described has been found to be effective and to produce an improved structure demonstrating the required strength levels. Thus the method described provides a versatile monolith with excellent structural integrity and meeting strength level requirements that can withstand high pressures.

CEC is well recognised as a powerful separation technique, as it combines the orthogonal separation parameters of chromatography and electrophoresis. CEC is a powerful analytical tool, which combines the high separation efficiency of capillary electrophoresis (CE) with the high selectivity and versatility of high performance liquid chromatography (HPLC). It provides a comprehensive multidimensional separation, since the peak capacity of the combined techniques is approximately the product of the independent methods. However, CEC has not impacted significantly on analytical separations due to the difficulties in obtaining robust, reproducible columns, as the capillaries are difficult to pack successfully. To overcome this, the growth of monolithic polymers as the stationary phase has emerged as the preferred method to obtain CEC capillaries. μCEC, where the growth of these polymers is far more readily controlled, is an obvious next step. μCEC, combining the advantages of miniaturisation with the powerful separation potential of CEC, was first developed in 1994 with the first monolithic packing developed in 2000, and since then, microchip chromatography has received considerable attention.

However, there is currently no monolithic packing in μCEC where critical parameters such as hydrophobicity, ionic interactions and porosity can be controlled for precise selectivity manipulations. Without the ability for selectivity manipulation, μCEC cannot realise its potential to become the foremost analytical tool for separation technologies. The μCEC chip outlined here allows for controlled monolithic stationary phase fabrication, combined with the ability for selectivity manipulation.

### Application of Monolith in Separations

Referring to drawings and in particular FIG. 3, an EMμ microchip 110 showing an etched separation channel 111, with sample and background electrolyte (BGE) inlets 112 and 114, and sample and BGE waste outlets 115 and 115a is provide. The separation channel 111 comprises a stationary phase 113 of an electroconducting polymer. The two electrodes inserted at the BGE inlet and outlet control the electrophoretic separation. The electrical circuit 116 of the polymer packing layer 113 will control the physical properties (e.g. pore size, ionic capacity, hydrophobicity) of the polymer packing itself by application of an external potential. The microchip 110 comprises two further electrodes 117a and 117b at the BGE inlet and outlet configured for use in separation methods to control the electrophoretic separation.

The microchip 110 may be used in chromatographic and electrophoretic separations Reversed-phase chromatographic separation is based on polarity criteria, size exclusion separation is based on overall molecule size, while CE separation depends on the charge-to-radius ratio. Therefore, any molecule mixtures which contain analytes with differences in one of these parameters can be separated using the microchip. Complex mixtures can be resolved using all three parameters, i.e. molecules of differing sizes will be separated by size; within a grouping of similarly sized molecules, they will be further separated by differences in their polarities; a grouping of molecules of similar size and polarity will be further separated based on their charge-to-radius ratio. In this way, very similar molecules, which cannot be separated by a single separation technique, will be separated based on manipulation of a number of subtle differences between them, by single potential control, or even potential-gradient control. Complex separation fields, such as metabonomics and proteomics, where potentially thousands of very similar compounds must be resolved from each other, will benefit enormously from this technique.

### Advantages of Monolithic Columns in CEC

In HPLC, an external mechanical pump is required to drive liquid through the column. In CE and CEC, the flow is driven by electroosmosis, under an applied electric field. In CEC the stationary phase not only affects separation of analytes, but also drives electroosmotic flow (EOF). If pore sizes become too small (<100 nm), an overlap of double layers can occur, decreasing or eliminating the EOF, diminishing the separation speed and reducing or preventing perfusive through flow in the pores. Nanotemplating, using templates of >100 nm, as provided by the method of fabrication described may be used to control the minimum pore size to ensure that EOF is not reduced during separation.

### Stationary Phase of Conducting Polymer and a Method of Separation Comprising Dynamic Control Thereof:

In a further aspect of the present teaching an analysis tool having monolithic stationary phase of a conducting or electroactive material for use in analytical chromatographic or electrophoretic separations is provided. Such a tool will now be described with reference to FIG. 3.

As was discussed above, the stationary phase 113 comprises a conducting or electroactive material and is configured such that the conductivity thereof is modifiable by the application and variation of a potential. In use, an electrical circuit 116 is provided to apply a potential to the stationary phase 113. The potential may be varied to vary and to control the physical properties of, for example, pore size, ionic capacity, hydrophobicity of the stationary phase. Thus the stationary phase 113 properties may be tuned, by selection and variation of the potential applied thereto. The potential applied is selected based on the properties of the sample analytes to be separated or analysed. The stationary phase may be of a conducting or electroactive polymer. The stationary phase may be of bulk porous polymer or nanotemplated polymer materials and may be provided in a microchip format. The stationary phase 113 may in particular be formed at least in part from Polyaniline (PANI).

The stationary phase 113 may be comprised of a stable and electrochemically reversible or quasi-reversible material. For example, the stationary phase 113 may be configured such that the porosity and/or hydrophobicity and/or conductivity thereof can be altered as required after a separation.

The stationary phase 113 may also be comprised of a conducting polymer composited with other conducting materials such as metallic materials (e.g., gold nanoparticles) and other conducting non-metallic materials such as carbon nanotubes. They may also be chemically combined with metallic complexes such as ruthenium complexes. For effective use as a stationary phase 113 the conducting polymer is configured as the ‘host’ for these materials in order to facilitate modulation of the conductivity. The monolithic stationary phase may also be of other suitable materials for example, porous silicon, the conductivity of which may be modulated.

Referring to FIG. 3—which it will be appreciated does not show the electrodes, a dynamic separation method using the stationary phase 113 will now be described. Such dynamic separation may be based on a single or combination of manipulations of the stationary phase.

The stationary phase 113 is selectively modified by application of potential at circuit 116 to tailor the properties thereof to the requirements of a separation, and to the properties of a particular analyte or set of analytes within the sample 120. By selection and variation of the potential applied to the stationary phase 113 the properties of, for example, porosity and/or hydrophobicity and/or ionic capacity and/or conductivity may be tuned.

The timing of this tuning may be determined as appropriate to the separation being effected. For example, the tuning may be performed at the outset of the separation. In addition or as an alternative, the potential applied to the stationary phase may be modified during separation. By varying the potential during separation it is possible to dynamically vary the properties of the stationary phase. For example, the pore size may be varied during separation enabling the monolith to be adjusted according to the requirements of the separation. This will allow for dynamic size exclusion chromatography, which separates molecules based on their size, their hydrodynamic volume. This is a widely used technique for purification and analysis of synthetic and biological polymers, such as proteins, polysaccharides and nucleic acids, which heretofore has not be possible within a separation column. As the separation continues, the pore size may be varied to allow or hinder the progression of selected molecules through the stationary phase.

The potential applied to the monolithic stationary phase 113 may also be varied so that analytes may be oxidised or reduced as they are being separated.

Thus, the oxidation or reduction potential can be precisely controlled, providing for the selective oxidation or reduction for example, enabling oxidising matrix interferants so that their retention time can be altered.

The method includes the following:
selection of an analysis device having a monolithic stationary phase 113, which may be provided in microchip format 110
coupling of stationary phase to external voltage 116
variation of voltage depending on sample/analyte 120 type
dynamic control of pore size, allowing for SEC
dynamic adjustment of hydrophobicity of stationary phase, altering analyte retention
variation of ionic capacity of stationary phase, enabling ion-exchange chromatography

TABLE 3
Optimisable parameters during dynamic separation:

| | Result on | |
|---|---|---|
| Parameter | Final Separation | Example |
| Variation of | Variation in pore size, | In situ |
| applied | allowing for | Environmental or |
| potential | dynamic size exclusion | biological sample |
| | chromatography | clean up |
| | Oxidation/reduction of | Induced |
| | selected analytes | morphology |
| | | changes to enable |
| | | separation of |
| | | similar molecules, |
| | | e.g. DNA |
| | | biomarkers |
| | Adjustment of hydrophobicity of | Illicit drug analysis |
| | stationary phase, altering analyte | |
| | retention | |

The stationary phase which is configured for dynamic modification and the separation method using such a stationary phase provides advantages over the prior art in that the stationary phase may be modified according to the specific properties of the sample analyte.

The stationary phases and methods described advantageously support and enable size exclusion chromatography both by the selective control of the form of the stationary phase as controlled in the process of fabrication by choice of electrochemical growth conditions, nanotemplating the monolith material and dopant selection, and/or perturbing the conducting “monolith” voltage during the separation to vary the diameter of the pore size. As such the method and phases described provide very powerful tools for separation.

Use of stationary phases of conducting or electroactive materials, in particular conducting or electroactive polymers, for example PANI, either in the format of a bulk porous polymer, or nanotemplated material, supports greatly improved methods of fabrication; and further provides for a dynamic separation based on a single or combination of selectivity manipulations, which cannot currently be offered by a conventional HPLC or CEC monolithic technology.

This method of fabrication is potentially low cost, simple to achieve and reproducible. As well as being highly controllable as a monolith material, material such as aniline are pH stable at least between pH 2-9 and have proven stability in 100% organic phase. By application of suitable potential, the monolith should be capable of expunging retained analytes and unwanted species to make it fully regenerable. Once regenerated, the potential can be used to tune the properties for the initial separation conditions. All these advantages make it applicable for a wide range of sample matrices ranging from biological (e.g., proteomic samples) to environmental complex matrices.

It will be appreciated that what has been described herein are exemplary arrangements of a capillary electrochromatography (CEC) analytical separation analysis device. Such a device comprises a stationary phase fabricated at least partially from a conducting or electroactive polymer. By applying a potential to the stationary phase it is possible to modify or control properties of the stationary phase.

It will be appreciated that the analysis devices described can also be applied analytical separations including chromatographic and non-chromatographic separations. Non-chromatographic separations include non-chromatographic continuous separation techniques and Membrane separation methods. Specific examples include, but are not limited to, dialysis, electrodialysis, gas permeation, electrodecantation, electrogravitation, reverse osmosis, ultrafiltration and solid phase extraction.

Advantageously, the arrangement of the present specification provides a fully conducting polymer as an in situ stationary phase or essentially a fully electrically conductive cell.

This overcomes problems of the prior art in which it was not possible to obtain stationary phase structures with full electrical conductivity as it has been necessary to use a scaffold to maintain structural integrity. The use of scaffolds has directly precluded obtaining stationary phase structures with full electrical conductivity and thereby precluded fabrication of electroconducting stationary phases.

By providing a stationary phase of pure conducting polymer nanomaterials the specification describes and advantageously provides a unique, tunable, monolithic stationary phase and removes the limitations in electrical conductivity of prior art arrangements incorporating a scaffold.

The present invention advantageously provides a stationary phase incorporating an electrode. The stationary phase and electrode are formed integrally to each other. In the prior art a stationary phase was often provided in an existing housing, such as capillaries which necessarily precluded application of an electrode.

The arrangement of the present specification advantageously further provides for the application of a potential to the stationary phase before and during separation by provision of the electrode and an electroconducting stationary phase

The present specification also allows for the monolithic stationary phase to be reproducibly microstructured during its fabrication, by electropolymerising through an ordered template, and offers precise control over the dimensions of the interconnecting pores.

It will be appreciated therefore that while exemplary methodologies and devices have been described heretofore that these are provided simply to assist in an understanding of the teaching and benefits of the present invention. Modifications can be made without departing from the spirit and the scope of the presently claimed invention. Integers and steps that are described with reference to one Figure may be interchanged or replaced with those of another Figure without departing from the present teaching.

The words comprises/comprising when used in this specification are to specify the presence of stated features, integers, steps or components but does not preclude the presence or addition of one or more other features, integers, steps, components or groups thereof.

1. A method of fabricating an analysis tool having an electroactive or conducting monolithic stationary phase, the method comprising electrochemically growing the stationary phase from a material comprising a monomer by effecting a polymerisation of the monomer to form an electroactive or conducting polymer.

2. The method as claimed in claim 1, further comprising applying a potential to the monomer during the polymerisation to control the electrochemical growth and a number of ultimate properties of the resultant stationary phase including at least one of: a porosity, a hydrophobicity, an ionic state, an oxidation state, and/or a colour of the resultant stationary phase.

3. (canceled)

4. The method as claimed in claim 2, further comprising modulating the potential to modulate the number of ultimate properties of the resultant polymer, the analysis tool being configured as a host to facilitate modulation of conductivity.

5-7. (canceled)

8. The method as claimed in claim 1 wherein the monomer comprises Aniline and the stationary phase comprises the polymer porous Polyaniline (PANI).

9. (canceled)

10. The method as claimed in claim 1, further comprising compositing the polymer with another conducting material including at least one of a conducting metallic material or a plurality of metallic nanoparticles.

11. The method as claimed in claim 1, further comprising compositing the polymer with another conducting non-metallic material, for example carbon nanotubes.

12. The method as claimed in claim 1, further comprising combining the polymer with a metallic complex.

13. (canceled)

14. The method as claimed in claim 1, further comprising adding a dopant to the monomer during polymerisation to control at least one of a structure and/or a number of redox properties of the stationary phase.

15. (canceled)

16. (canceled)

17. The method as claimed in claim 1, wherein electrochemically growing the stationary phase includes electrochemically growing the stationary phase in-situ within the analysis tool.

18. (canceled)

19. The method as claimed in claim 1 further comprising providing a template configured to define a pore size and a structure of the stationary phase, and wherein electrochemically growing the stationary phase includes electrochemically growing the stationary phase in the presence of the template.

20. The method as claimed in claim 19 wherein providing a template includes depositing the template in the channel prior to polymerisation of the monomer.

21. The method as claimed in claim 19,
further comprising co-depositing the template with the polymer by electropolymerisation of the monomer in the presence of the template.

22. (canceled)

23. The method as claimed in claim 19 wherein the template is configured to define permselective pores, typically having dimensions of <100 nm.

24. The method as claimed in claim 19 wherein the template is configured to define pores of dimensions >20 nm.

25. The method as claimed in claim 19 wherein the template is configured to define pore sizes of >100 nm for electro-osmosis.

26. The method as claimed in claim 19, further comprising removing the template subsequent to the growth of the stationary phase.

27. The method as claimed in claim 19 wherein the template comprises a soluble material configured to be dissolved after the stationary phase is grown.

28. The method as claimed in claim 1 further comprising fabricating the monolithic stationary phase in one of chip or microchip format, column or capillary column format.

29-38. (canceled)

39. The method as claimed in claim 1, further comprising forming an electrode cell having a separation channel, the electrode cell comprising a working electrode, a reference electrode and an auxiliary electrode, the working electrode formed by sputter coating the base of the separation channel with a conducting material, wherein the polymerisation of the monomer is effected on the working electrode by applying a potential between the working and the reference electrode.

40-43. (canceled)

44. The method as claimed in claim 1 wherein the analysis tool is provided with an electrode cell configuration which comprises control means for applying and controlling the potential applied while the stationary phase is being grown.

45-47. (canceled)

48. The method as claimed in claim 19, further comprising locating the template in a channel, the channel defining the ultimate location of the stationary phase.

49-50. (canceled)

51. The method as claimed in claim 1 wherein the stationary phase comprises a 3D monolithic stationary phase.

52. The method as claimed in claim 1 wherein the stationary phase comprises a monolithic HPLC stationary phase.

53. An analysis tool for use in analytical separations, the analysis tool having a monolithic stationary phase wherein the stationary phase is at least partially comprised of an electroactive or conducting polymer and wherein the stationary phase is grown electrochemically.

54-57. (canceled)

58. The analysis tool as claimed in claim 53, further comprising a controller to apply a potential to the stationary phase to controlling properties of the stationary phase.

59. (canceled)

60. The analysis tool as claimed in claim 58 wherein application of a potential to the stationary phase enables modification of one or more properties of the stationary phase including at least one of: a porosity, a density, an ionic capacity, a hydrophobicity, a conductivity, an oxidation state, or a colour.

61. The analysis tool as claimed in claim 58 wherein the stationary phase is configurable such that one or more properties of the stationary phase are dynamically modifiable during a separation process.

62. The analysis tool as claimed in claim 61 wherein the dynamic modification is operably provided to tune the properties of the stationary phase to one or more properties of one or more analytes to be separated during use of the analysis tool in the analytical separations.

63-66. (canceled)

67. A capillary electrochromatographic analytical separation method for identification of sample analytes comprising:
providing an analysis tool having a stationary phase comprising a conducting or electroactive material; at least partially comprised of an electroactive or conducting polymer;
applying a potential to the stationary phase to modify and tune a number of properties of the stationary phase.

68-75. (canceled)

76. The capillary electrochromatographic analytical separation method as claimed in claim 67, further comprising varying the potential applied to vary an ionic capacity of the stationary phase enabling ion-exchange chromatography.

77. The capillary electrochromatographic analytical separation method as claimed in claim 67, further comprising applying or varying the potential applied to the stationary phase during a separation to effect oxidation or reduction of analytes therein.

78. A method of fabricating an analysis tool having a stationary phase comprising a conducting or electroactive material at least partially comprised of an electroactive or conducting polymer comprising:
providing a sacrificial template configured to define a pore size and a structure of the stationary phase,
introducing a monomer into the template; and
electrochemically growing the stationary phase in the presence of the template by effecting a polymerisation of the monomer.

79. The method as claimed in claim 78, further comprising:
providing a channel; and
depositing the template in the channel prior to polymerisation of the monomer.

80. The method as claimed in claim 78, further comprising
co-depositing the template with the polymer by electropolymerisation of the monomer in the presence of the template.

81. The method as claimed in claim 78 wherein the template is configured to define a number of permselective pores.

82. The method as claimed in claim 78, further comprising:
removing the template subsequent to the growth of the stationary phase.

83. The method as claimed in claim 78 wherein the template comprises a soluble material configured to be dissolved after the stationary phase is grown.

84. The method of claim 78 wherein the polymerisation of the monomer effects generation of a monolithic structure.
